(19) United States
(12) Patent Application Publication
(10) Pub. No.: US 2003/0167675 A1
(43) Pub. Date: Sep. 11, 2003

(54) Fishing lure, method of making the lure, and lure making kit

(75) Inventors: Bokuyo Noguchi, Yokohama-Shi (JP); Kiyoshi Ochiai, Atsugi-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NIPPON FLOUR MILLS CO., LTD., Tokyo (JP)

(21) Appl. No.: 10/342,353

(22) Filed: Jan. 15, 2003

(30) Foreign Application Priority Data
Jan. 21, 2002 (JP) 2002-011065

(51) Int. Cl. A23L 1/00; A01K 85/00

(52) U.S. Cl. 43/42; 43/42.1; 43/42.24; 426/1

(57) ABSTRACT

An artificial fishing lure is produced by immersing a shaped material in the form of a gel including curdlan in a liquid containing propylene glycol and taking the shaped material out of the liquid. A method of producing an artificial fishing lure includes the steps of preparing a mixture containing water and curdlan, heating the mixture to form a gel and mold the gel so that a shaped material in the form of a gel can be obtained, immersing the shaped material in a liquid containing propylene glycol, and taking the shaped material out of the liquid. A lure making kit includes curdlan and propylene glycol.

### FIELD OF THE INVENTION

The present invention relates to an artificial fishing lure and a method of making the fishing lure. More particularly, the present invention relates to an artificial lure for catching flesh-eating fish, notably bass, and the method of making the above-mentioned artificial lure. In addition, the present invention relates to a lure making kit to which the aforementioned method is applied.

### BACKGROUND OF THE INVENTION

In the field of lure fishing, the fishermen use artificial bait called “ure”. The lure is typically made from a rigid or non-rigid plastic material and a hard or soft rubber. Lures made from the rigid plastic material and hard rubber are called hard bodied lures; while lures made from the material with flexibility and elasticity, which act in the water as if they were living worms, are called soft lures or worms.

The lure fishing is popular in the sport of fishing, especially among women and children because it is easier to maintain and control the artificial lure when compared with the case where the living worms are used as bait.

However, the above-mentioned hard bodied lures and worms made from the plastic and rubber materials have become an issue of public in recent years on the grounds that such lures do damage to birds and fish when swallowed by mistake and that the lures made from persistent materials cause environmental pollution. To solve the aforementioned problems, application of biodegradable plastics to artificial lures has started. Although the research has been in progress, the above-mentioned resolution is not ultimate. This is because even the biodegradable plastic materials are not easily digested if the birds and fish swallow them, and it takes several years or several tens of years for such biodegradable plastic materials to completely degrade in the soil.

A variety of materials are conventionally proposed for the artificial fishing lures. For example, artificial lures made from arum root are disclosed in JP KOKAI Nos. Hei 10-28493, Hei 10-191840 and Hei 11-243813; gelan gum, in JP KOKAI No. Hei 11-46626; and biodegradable plastic materials, in JP KOKAI No. Hei 11-75625, Hei 11-137127 and Hei 11-169025. The arum root has the shortcoming as the material for the fishing lures that the pH control is essential in molding the arum root because arum root does not coagulate till it is alkalified. In addition, lures made from arum root cannot be finished to have elaborate design.

It is conventionally known that the physical properties of the following food materials are similar to those of the existing worm type fishing lures: gelling agents capable of forming a gel by cooling, such as gelatin, agar, and carrageenan; gelling agents reactive to a bivalent cation, such as slightly methoxylated pectin and carrageenan; and gelling agents capable of forming a gel upon heating, such as albumen. However, no food material can meet all the requirements (1) to (5) shown below.

(1) Thermo-irreversibility, not affected by a change in temperature. For example, the material is stable even when exposed to a burning sun in summer or the intense cold in winter, sterilized for retorting process and stored in a refrigerator or freezer.

(2) Proper flexibility, elasticity and strength in physical properties.

(3) Good workability in the production process and adaptability to the production facilities currently in widespread use.

(4) Suitability for mass production.

(5) Sufficient resistance to swelling and brittleness even when the material is immersed in water for a long time.

In consideration of the above-mentioned requirements, the inventors of the present invention proposed a fishing lure that is obtained by molding a material gelatinized using curdlan, as disclosed in JP KOKAI No. 2001-309737. However, there is an increasing demand for the practical requirements of the fishing lures. More specifically, fishing lures are desired to have proper flexibility and sufficient strength, tight grip on a fish-hook, and excellent storage stability, moisture retention, and water resistance.

The strength of the lure herein used means that required to bear the centrifugal force applied to the lure when a long cast is made in lure fishing, and endure the force applied to the lure when the lure knocks against various obstacles such as stones at the bottom of the water and rubs against reeds and the like. The lure needs proper flexibility so as to temper fish to bite the lure by smoothly acting as a living worm in the water. Also, the tight grip of the fishing lure on the fish-hook is necessary to securely hold the lure by the fish-hook for a long time, thereby faithfully reflecting the rod action driven by the fisherman's technique in the movement of the fishing worm. The moisture retention is also required to prevent the worm-like lure taken out of the package or container from getting dry and hard before the fishing lure is put on a hook. The water resistance herein used is also one of the properties required for the fishing lure. To be more specific, if the fishing worm is lacking in water resistance, the worm tends to absorb lots of water and swell in the water. Such a tendency can increase the risk of abruptly decreasing the strength of the fishing lure and loosening the grip of the fishing lure on the hook.

### SUMMARY OF THE INVENTION

Accordingly, an object of the present invention is to provide an artificial fishing lure and a method of making the fishing lure, which lure employs a food material that has a minimum adverse effect on the environment and living things to replace the conventional lures made from rubbers and plastic materials, and that shows excellent physical properties, that is, sufficient flexibility and elasticity that can compare favorably with those of the lures made from the rubbers and plastic materials. Further, it is another object of the present invention to provide an artificial lure for fishing which is free of the above-mentioned shortcomings in the known art and can meet the practical requirements more severely, and to provide a method of producing such an artificial fishing lure, and further, to provide a lure making kit.

The inventors of the present invention have studied intensively to achieve the above-mentioned objects. Consequently, it has been found that a product obtained by immersing a shaped material made into a gel using curdlan in a liquid comprising polypropylene glycol and taking the shaped material out of the liquid is suitable for fishing lures. The present invention has been accomplished based on the above-mentioned discovery.

Accordingly, the present invention is an artificial fishing lure produced by immersing a shaped material in a gel form comprising curdlan in a liquid comprising polypropylene glycol and taking the shaped material out of the liquid.

Further, another aspect of the present invention is a method of making an artificial fishing lure comprising the steps of preparing a mixture comprising water and curdlan, heating the mixture to form a gel and mold the gel so that a shaped material in a gel form can be obtained, immersing the shaped material in a liquid comprising propylene glycol, and taking the shaped material out of the liquid. The present invention is also directed to a method of making an artificial fishing lure comprising the steps of preparing a mixture comprising water and curdlan, heating the mixture to form a gel, cutting the gel so that a shaped material in the form of a gel can be obtained, immersing the shaped material in a liquid comprising propylene glycol, and taking the shaped material out of the liquid.

Furthermore, the present invention is directed to a lure making kit comprising curdlan and propylene glycol.

The liquid in which the shaped material is immersed may further comprise lecithin. It is more preferable that the liquid comprise propylene glycol, lecithin, and glycerin. Further, it is most preferable that the liquid for use in the immersion comprise polypropylene glycol, lecithin, glycerin, and calcium chloride.

The shape, size, and thickness of the artificial fishing lure according to the present invention are not particularly limited as long as it can be used as the fishing lure in practice.

### DETAILED DESCRIPTION OF THE INVENTION

Curdlan, which is a fermented polysaccharide produced from glucose using a fermentative micro-organism such as Agrobacterium biovar, has been produced on an industrial scale. Curdlan has been widely used in the field of food industry by taking advantage of its property of forming a gel upon heating. Curdlan received a seal of approval as a food additive. Curdlan is found to be considerably less toxic.

Curdlan is commercially available in the form of an odorless white powder, and the commercial products may be used in the present invention. For example, commercially available products “Curdlan” and “Curdlan N”, both being trademarks of Takeda Chemical Industries, Ltd, may be applied to the present invention.

As mentioned above, curdlan has the property of forming a gel upon heating its aqueous suspension. In addition, it is also known that when the aqueous suspension of curdlan is heated to about 80° C. or more, a thermo-irreversible gel is formed.

The above-mentioned aqueous suspension of curdlan can be prepared by mixing curdlan and water and vigorously stirring the mixture. The concentration of curdlan in the aqueous suspension of curdlan, which is not particularly limited as long as the operation for forming a gel is not hindered, is typically 1 to 15 parts by weight, preferably 3 to 10 parts by weight, with respect to 100 parts by weight of water. When the amount of curdlan exceeds 15 parts by weight, the obtained product is lacking in flexibility. When the amount of curdlan is less than one part by weight, the shape retention properties become poor, so that the resultant product is susceptible to damage. It is preferable that stirring of the mixture of curdlan and water be achieved by a shearing mixing action. To be more specific, the mixture of water and curdlan may be vigorously stirred using a cutter mixer, juicing blender, or homogenizer to sufficiently disperse the particles of curdlan and make each particle fully swell. The mixture is subjected to the mixing operation for about 2 to about 30 minutes, for example, using a commercially available mill mixer for home use “MX-L20GA” (trademark), made by Toshiba Corporation (100 V, 255 W, 50-60 Hz) so as to have an appropriate viscosity at the final stage.

Coloring materials such as food color; starches such as corn starch, potato starch, flour starch and tapioca starch; and powders made of the grain of cereals such as wheat flour, corn flour, rice flour, glutinous rice flour, potato flour, and yam flour may be added to the mixture of water and curdlan when necessary. In this case, it is preferable that the coloring agent be contained in an amount of 0.001 to 0.5 parts by weight, and the starches and/or cereal powders be contained in an amount of 1 to 10 parts by weight, with respect to 100 parts by weight of water.

Curdlan, the food color, the starches, and cereal powders may be added separately to water. Alternatively, curdlan may be mixed together with the food color, the starches and the cereal powders in advance to prepare a mixture, and thereafter water may be added to the mixture.

The resultant mixture may be subjected to deaeration under reduced pressure, for example, using a vacuum packaging machine in order to remove air bubbles from the mixture and thus increase the strength of a gel to be formed. Alternatively, the above-mentioned raw materials may be subjected to the mixing operation simultaneously with the deaeration treatment by use of a vacuum mixer, for example, a commercially available vacuum mixer equipped with two rotors designed for mixing flour up to 12 kg, made by Suzukimenko Co., Ltd.

It is proper that the viscosity of the mixture finally obtained be controlled to 3 to 25 poise. The desired viscosity of the mixture can be obtained by appropriately adjusting the amount of curdlan and the amounts of additives, and controlling the mixing load and the mixing time. The viscosity of the mixture may be determined using a viscometer, for example, a RION viscometer (model VT-04, made by Rion Co., Ltd.). The resultant mixture will also be hereinafter referred to as a dough.

The dough obtained by the steps mentioned above is gelatinized by heating. To be more specific, the dough may be charged into a mold and subjected to heat treatment to form a gel in the mold. Any materials can be used for the mold as long as there is no problem in thermal conductivity and compatibility with the heating means. Preferably used are molds for injection molding made of metals such as aluminum, brass, iron and stainless steel, or molds made of other materials, such as silicone, heat-resistant plastic material, glass and wood. The mold with a desired shape, for example, in the shape of an earthworm, small fry, shrimp, crayfish, crab, frog, clamworm, cuttlefish, octopus, large caterpillar, and various insects can be used in the present invention.

Any heating means can be selected depending upon the kind of mold. Specific examples of the heating means include direct heating, which is applicable especially when a metal mold is used; baking in an oven; steaming by use of a steamer; and boiling. It is proper to control the temperature of the dough to 80 to 100° C., preferably 85 to 98° C. The heating time is suitably in the range of about 5 to 50 minutes, preferably about 8 to 20 minutes. When the temperature of the dough is less than 80° C., the gelation of the dough does not take place. On other hands, when the dough is heated over 100° C., air bubbles may be trapped into the obtained product because of boiling of water. Further, when the heating time is less than 5 minutes, the strength of the obtained gel is insufficient. The prolonged heating which lasts for over 50 minutes is in vain because no significant change will occur.

After completion of the gel formation by heating, the molded material may be taken out of the mold by opening the mold.

The surface of the molded material can be decorated optionally in such a manner that pieces of silver foil for food or vermiculite are dispersed over the inner surface of the mold before the dough is charged into the mold. Further, an eyeball-like ornament can be embedded in the dough. It is also possible to fabricate a molded material with a variety of patterns by using a plurality of dough materials with different colors. The dough may be injected into the mold with a syringe free from a needle.

A baking machine may also be used in the present invention to gelatinize the dough and mold the dough into a desired shape by application of heat thereto. In the baking machine, the above-mentioned dough is set on a grill plate of which surface temperature is appropriately controlled. By using the baking machine, the dough can be molded as desired, with a gel being formed upon application of heat. To be more specific, there can be employed a baking machine capable of simultaneously baking and molding the dough, for example, the conventional baking machine with a grill plate having indentation designed for making Japanese-style traditional pancakes such as fish-shaped or doll-shaped pancakes stuffed with bean jam and octopus-containing balls. Any other baking machine with a grill plate which is made into a desired shape can be utilized in the present invention.

Or, an automated line heating system can be used in the present invention, which system is provided with a grill plate continuously fed and designed for making products with a desired shape and a depositor for depositing the dough onto the grill plate.

On the grill plate, the gelation of the dough proceeds gradually toward the center of the dough from the outside thereof, so that any additional material may be set in the center of the dough. Further, the dough may be sandwiched between the upper and lower grill plates, both of which can produce a molded material in combination. Or, the dough may be turned upside down on the grill plate in the course of molding for obtaining complete products.

When the molded lure product is made using such a grill plate, the surface of the molded lure can also be decorated optionally, for example, by dispersing pieces of silver foil for food or vermiculite over the inner surface of the indentation of the grill plate before the dough is set on the grill plate. Further, an eyeball-like ornament can be embedded in the dough. It is also possible to fabricate a molded lure with a variety of patterns by using a plurality of dough materials with different colors. The dough may be injected into the indentation of the grill plate with a syringe free from a needle.

In addition to the above, a baking machine with a flat hot plate such a hot plate and an iron plate can be used for heating the dough to form a gel. For example, the dough may be spread over the flat heated plate and then turned upside down, so that the dough can be made into a flat sheet-shaped gel with a thickness of about 3 to 20 mm. The flat sheet-shaped gel can be cut with a knife or die-cut with a die to have a desired shape. In this case, the obtained material can also be decorated with some accessories and made of a plurality of dough materials with different colors as mentioned above.

In the case where the above-mentioned flat hot plate is used, a syringe free from the needle is filled with the dough and the dough is extruded from the syringe onto the hot plate so as to make the dough into any shape, for example, in the shape of an earthworm. After appropriately heating the dough on the hot plate, the dough is turned upside down. An earthworm-shaped lure can be obtained by this method. Or, a metal die with a desired shape is set on the flat hot plate and filled with the dough, whereby the dough is molded into a shape of the die, and at the same time, the dough forms a gel.

It is preferable that the viscosity of the dough be in the range of 3 to 25 poise as mentioned above. When the viscosity of the dough exceeds 25 poise, the fluidity of the dough becomes poor, so that the dough cannot be cut clearly during the molding operation and cannot extend sufficiently upon heating. When the dough has a viscosity of less than 3 poise, the dough runs from the depositor so as to lower the workability.

The heating temperature and the heating time may appropriately be selected so that the gelation of the dough can proceed sufficiently. It is desirable that the grill plate be preset to a relatively high temperature to speedily elevate the temperature of the dough. The gelation of the dough can thus proceed quickly. It is proper that the surface temperature of the grill plate or hot plate be set to 90 to 160° C., preferably 110 to 140° C. Under such conditions, 15 g of dough can form a gel in about 3 to 5 minutes. When the surface temperature of the grill plate or hot plate is less than 90° C., gelation will not take place or it will take much time to form a gel. When the surface temperature exceeds 160° C., the water content in the dough boils when the dough comes in contact with the heated grill plate, which will unfavorably make the surface of the shaped material rough.

To prevent the dough from burning in the baking operation, a mold release agent or edible fat and oil may be applied to the surface of the grill plate or hot plate.

After the dough forms a gel, which is molded into a desired shape, the shaped material is immersed into a liquid comprising propylene glycol for a predetermined period of time. The above-mentioned liquid may consist of propylene glycol. The amount of propylene glycol is suitably in the range of 50 to 150 parts by weight with respect to 100 parts by weight of the shaped material. The liquid may further comprise lecithin. In this case, it is proper that the amount of lecithin be in the range of 0.1 to 20 parts by weight with respect to 100 parts by weight of the shaped material. In this case, soybean lecithin and yolk lecithin can be used.

The above-mentioned liquid may further comprise lecithin and glycerin in addition to propylene glycol. The amount of glycerin is suitably in the range of 0.1 to 70 parts by weight with respect to 100 parts by weight of the shaped material. The most preferable embodiment of the liquid comprises propylene glycol, lecithin, glycerin, and calcium chloride. In this case, the amount of calcium chloride is suitably in the range of 0.1 to 15 parts by weight with respect to 100 parts by weight of the shaped material.

The above-mentioned liquid may further comprise an agent for attracting fish, such as salt, amino acid, nucleic acid, for example, disodium 5′-ribonucleotide and sodium 5′-inosinate, fish extract, fish soluble, squid liver oil, chrysalis oil, and saccharides. When the liquid contains salt, the amount of salt is suitably in the range of 0.1 to 15 parts by weight with respect to 100 parts by weight of the shaped material. When the liquid contains the above-mentioned fish attracting agent, the total amount of such an agent is suitably in the range of about 1 to 20 parts by weight with respect to 100 parts by weight of the shaped material.

The shaped material may be immersed in the above-mentioned liquid which is controlled to 5 to 35° C. or at room temperature for about 10 to 48 hours. The proper amount of the liquid is as stated above. In the case where the amount of liquid is too small relative to the shaped material, or the immersion time is insufficient, there is the tendency that the resultant fishing lure product cannot meet the requirements, that is, sufficient strength, tight grip on the hook, and excellent storage stability, moisture retention, and water resistance. On the other hand, when there exists too much liquid relative to the shaped material immersed therein, the obtained product tends to be lacking in flexibility. Even though the shaped material is immersed in the liquid for more than 48 hours, there occurs no significant change.

After the shaped material is immersed in the liquid for a predetermined period of time, the shaped material is taken out of the liquid and the liquid attached to the material is removed therefrom by draining or wiping. Thus, a final product, namely, a fishing lure of the present invention can be obtained.

To get the fishing lure thus obtained ready for fishing, the lure may be put on a hook by conventional methods.

The present invention also provides a lure making kit comprising curdlan and propylene glycol. Curdlan may be held as it is in a container for the kit, or separately packed in the kit. For the artificial fishing lure making kit, curdlan may be used alone or optionally in combination with at least one additive in a powdered form selected from the above-mentioned coloring agents, starches and cereal powders. In this case, the amount of starches and/or cereal powders is suitably in the range of 1 to 10 parts by weight and the amount of food color is suitably in the range of 0.001 to 0.5 parts by weight, with respect to 1 to 15 parts by weight of curdlan. Such additives may be individually packed in the kit.

The kit of the present invention comprises propylene glycol, which is packed aside from curdlan. The propylene glycol may be mixed with lecithin, or lecithin and glycerin, or lecithin, glycerin and calcium chloride. Lecithin, glycerin, and calcium chloride may be individually packed aside from propylene glycol in the kit.

The lure making kit according to the present invention may further comprise a pair of tweezers, a syringe, a mold, and a grill plate.

The present invention will be illustrated in detail with reference to the Examples below.

### EXAMPLES

### Reference Example

The following components were placed in a juicing blender and vigorously stirred for 10 minutes to obtain a dough with a viscosity of 12 poise.

| | |
|---|---|
| Water | 1000 g |
| Curdlan | 50 g |
| Corn starch | 10 g |
| Coloring agent | 2 g |

Using a commercially available desk-top automatic vacuum-packaging machine “Tospack” (trademark), made by Tosei Electric Corporation, the dough was subjected to deaeration for 5 minutes under a reduced pressure of −76 cmHg. The resultant dough was charged into an aluminum mold for injection molding in the shape of an earthworm with a diameter of 6 mm and a length of 80 mm with a syringe. The dough-filled mold was set in a steamer and heated at 95° C. for 15 minutes. After the completion of heating, the dough in the mold formed a gel, thereby obtaining a sample product No. 1 shaped into an earthworm with sufficient elasticity and proper flexibility.

### Example 1

The earthworm-shaped sample product No. 1 was prepared in the same manner as in Reference Example.

A liquid in which the sample product was immersed was prepared by thoroughly mixing 5 parts by weight of salt, one part by weight of shrimp extract, and 49 parts by weight of propylene glycol, with respect to 100 parts by weight of the above-mentioned sample product. The sample product was immersed in the resultant liquid at 20° C. for 24 hours. The sample product was taken out of the liquid and the liquid was wiped off the surface of the sample product. Thus, a sample product No. (2)-1 was obtained.

The procedure for preparing the sample product No. (2)-1 as mentioned above was repeated except that the amount of propylene glycol for use in the formulation for the liquid was changed from 49 parts by weight to 60 parts by weight. Thus, a sample product No. (2)-2 was obtained.

The procedure for preparing the sample product No. (2)-1 as mentioned above was repeated except that the amount of propylene glycol for use in the formulation for the liquid was changed from 49 parts by weight to 100 parts by weight. Thus, a sample product No. (2)-3 was obtained.

The procedure for preparing the sample product No. (2)-1 as mentioned above was repeated except that the amount of propylene glycol for use in the formulation for the liquid was changed from 49 parts by weight to 140 parts by weight. Thus, a sample product No. (2)-4 was obtained.

The procedure for preparing the sample product No. (2)-1 as mentioned above was repeated except that the amount of propylene glycol for use in the formulation for the liquid was changed from 49 parts by weight to 151 parts by weight. Thus, a sample product No. (2)-5 was obtained.

### Example 2

The procedure for preparing the sample product No. (2)-3 as mentioned in Example 1 was repeated except that the immersion time was reduced to 9 hours. Thus, a sample product No. (3)-1 was obtained.

The procedure for preparing the sample product No. (2)-3 as mentioned in Example 1 was repeated except that the immersion time was reduced to 15 hours. Thus, a sample product No. (3)-2 was obtained.

The procedure for preparing the sample product No. (2)-3 as mentioned in Example 1 was repeated except that the immersion time was increased to 49 hours. Thus, a sample product No. (3)-3 was obtained.

### Example 3

The earthworm-shaped sample product No. 1 was prepared in the same manner as in Reference Example.

A liquid in which the sample product was immersed was prepared by thoroughly mixing 5 parts by weight of salt, one part by weight of shrimp extract, 90 parts by weight of propylene glycol, and 10 parts by weight of lecithin, with respect to 100 parts by weight of the above-mentioned sample product. The sample product was immersed in the resultant liquid at 20° C. for 24 hours. The sample product was taken out of the liquid and the liquid was wiped off the surface of the sample-product. Thus, a sample product No. (4) was obtained.

### Example 4

The earthworm-shaped sample product No. 1 was prepared in the same manner as in Reference Example.

A liquid in which the sample product was immersed was prepared by thoroughly mixing 5 parts by weight of salt, one part by weight of shrimp extract, 70 parts by weight of propylene glycol, 10 parts by weight of lecithin, and 20 parts by weight of glycerin, with respect to 100 parts by weight of the above-mentioned sample product. The sample product was immersed in the resultant liquid at 20° C. for 24 hours. The sample product was taken out of the liquid and the liquid was wiped off the surface of the sample product. Thus, a sample product No. (5) was obtained.

### Example 5

The earthworm-shaped sample product No. 1 was prepared in the same manner as in Reference Example.

A liquid in which the sample product was immersed was prepared by thoroughly mixing 5 parts by weight of salt, one part by weight of shrimp extract, 70 parts by weight of propylene glycol, 10 parts by weight of lecithin, 20 parts by weight of glycerin, and 6 parts by weight of calcium chloride, with respect to 100 parts by weight of the above-mentioned sample product. The sample product was immersed in the resultant liquid at 20° C. for 24 hours. The sample product was taken out of the liquid and the liquid was wiped off the surface of the sample product. Thus, a sample product No. (6) was obtained.

Each of the fishing lure sample products obtained in the above-mentioned Examples was subjected to the following evaluation tests.

[Breaking Strength and Breaking Workload]

The strength of each fishing lure was evaluated using a commercially available tester “FUDOH Rheometer RT-3002D” (trademark), made by Rheotech Corporation, an adapter specifically designed to a tester equipped with a razor-blade for measuring the breaking strength being attached. The breaking strength (unit: g) and the workload (unit: erg) were determined by perpendicularly cutting each of the earthworm-shaped lures at the center thereof.

[Flexibility, Grip of Lure on Hook, Moisture Retention Properties, and Water Resistance]

The above-mentioned properties of the fishing lures were evaluated in such a manner that ten anglers who were fond of bass fishing actually tried the lures in black bass fishing. All the sample products, ten of each kind, were distributed to each individual member. To evaluate the sample products equally, each individual member tried all the sample products one by one. Each sample product was subjected to the actual fishing for 3 hours unless it was lost for some reason. The sample products were changed after a lapse of the predetermined time or a loss of the product.

The evaluation results were marked on a scale from 1 to 10 on an organoleptic basis, and expressed as the following symbols from the obtained average:

⊚ from 8 or more to 10 on average

◯ from 6 or more to less than 8 on average

Δ from 4 or more to less than 6 on average

X less than 4 on average

[Storage Stability]

Each fishing lure sample product was heat-sealed in a plastic bag, and the plastic bag was maintained in a thermostat at 30° C. for 12 months. After that, the viable cell count was determined by a conventional method.

[Results of Fishing]

The total number of black bass caught in the above-mentioned test was counted and the average number of black bass caught by using each lure sample product was obtained.

The results of the above-mentioned evaluation tests are shown in Table 1.

TABLE 1

| | | Breaking | | | Mois- | | Storage | No. of |
|---|---|---|---|---|---|---|---|---|
| | Breaking | Work- | | Grip | Ture | Water | Stability | fish |
| Sample | Strength | Load | Flexi- | on | Reten- | Resist- | (viable cell | caught |
| Product | (g) | (erg) | Bility | Hook | Tion | ance | count) | (per lure) |
| (1) | 204.9 | 5020 | ⊚ | X | X | X | >10⁶ | 0.02 |
| (2)-1 | 360.7 | 7236 | ◯ | Δ | Δ | X | >10⁶ | 0.05 |
| (2)-2 | 410.1 | 9238 | Δ | ◯ | ◯ | Δ | <300 | 0.05 |
| (2)-3 | 491.2 | 13043 | Δ | ◯ | ◯ | Δ | <300 | 0.16 |
| (2)-4 | 500.9 | 15526 | Δ | ◯ | ◯ | Δ | <300 | 0.09 |
| (2)-5 | 538.4 | 17226 | X | ◯ | ◯ | ◯ | <300 | 0.04 |
| (3)-1 | 370.5 | 7836 | ◯ | Δ | Δ | X | >10⁶ | 0.10 |
| (3)-2 | 450.2 | 10483 | Δ | ◯ | ◯ | Δ | 8 × 10⁵ | 0.17 |
| (3)-3 | 500.1 | 14462 | Δ | ◯ | ◯ | Δ | <300 | 0.18 |
| (4) | 923.4 | 23539 | ◯ | ⊚ | ◯ | ⊚ | <300 | 0.33 |
| (5) | 899.9 | 23889 | ⊚ | ⊚ | ◯ | ⊚ | <300 | 0.46 |
| (6) | 946.3 | 24553 | ⊚ | ⊚ | ⊚ | ⊚ | <300 | 0.43 |

Effect of the Invention

The artificial fishing lure of the present invention is in the form of a gel, which is obtained by taking advantage of the properties of curdlan that a thermo-irreversible gel can be formed. Namely, the fishing lure is stable even when exposed to elevated temperatures or stored at low temperatures owing to the properties of curdlan. In addition, when the fishing lure is immersed in water for a long period of time, the physical properties of the lure are stable. The fishing lure of the present invention does no harm to the environment and the living things, and the flexibility, elasticity and strength of the lure are quite as good as those of currently used lures made from rubbers and plastic materials. The lure of the present invention can meet the practical requirements for fishing lures, that is, proper flexibility, sufficient strength, tight grip on a hook, excellent storage stability, sufficient moisture retention when exposed to the air, and water resistance. As a consequence, the strength of the fishing lure according to the present invention can be maintained when immersed in water for a long time, so that the lure can be securely held by a fish-hook.

According to the method of making the artificial fishing lure of the present invention, the above-mentioned fishing lures can be mass-produced with no difficulty. In addition, the lure making kit according to the present invention can allow the users to easily make a favorable fishing lure at home. According to the method of making the lure, when the shaped material is immersed in a specific liquid, there occurs some replacement of water trapped in the shaped material by the liquid in which the shaped material is immersed. The result is that the final product can last for a long time because of the lowered water activity of the product. In the conventional method of making the fishing lures, when the amount of a gelling agent such as curdlan is increased to enhance the strength of the obtained product, the product unfavorably tends to get rigid although the strength is increased. In contrast to this, the method of the present invention can significantly enhance the strength of the lure product leaving the flexibility thereof unchanged without increasing the amount of the gelling agent.

What is claimed is:

1. An artificial fishing lure produced by immersing a shaped material in the form of a gel comprising curdlan in a liquid comprising propylene glycol and taking the shaped material out of the liquid.

2. A method of producing an artificial fishing lure comprising the steps of:
preparing a mixture comprising water and curdlan,
heating the mixture to form a gel and mold the gel so that a shaped material in the form of a gel can be obtained,
immersing the shaped material in a liquid comprising propylene glycol, and
taking the shaped material out of the liquid.

3. The method of claim 2, wherein said liquid further comprises lecithin.

4. The method of claim 3, wherein said liquid further comprises glycerin.

5. The method of claim 4, wherein said liquid further comprises calcium chloride.

6. A method of producing an artificial fishing lure comprising the steps of:
preparing a mixture comprising water and curdlan,
heating the mixture to form a gel,
cutting the gel so that a shaped material in the form of a gel can be obtained,
immersing the shaped material in a liquid comprising propylene glycol, and
taking the shaped material out of the liquid.

7. The method of claim 6, wherein said liquid further comprises lecithin.

8. The method of claim 7, wherein said liquid further comprises glycerin.

9. The method of claim 8, wherein said liquid further comprises calcium chloride.

10. A lure making kit comprising curdlan and propylene glycol.

11. The lure making kit of claim 10 further comprising lecithin.

12. The lure making kit of claim 11 further comprising glycerin.

13. The lure making kit of claim 12 further comprising calcium chloride.
